(19) United States
(12) Patent Application Publication
(10) Pub. No.: US 2024/0212284 A1
(43) Pub. Date: Jun. 27, 2024

(54) GENERATION OF A SURFACE MESH FROM A VOXEL MODEL OF A THREE-DIMENSIONAL ENVIRONMENT

(71) Applicant: NOVAQUARK, Paris (FR)

(72) Inventors: Guillaume GRIS, Paris (FR); Philip Ulrich TRETTNER, Aachen (DE)

(21) Appl. No.: 18/563,289

(22) PCT Filed: May 13, 2022
(86) PCT No.: PCT/FR2022/050913

§ 371 Date: Nov. 21, 2023

(30) Foreign Application Priority Data
May 21, 2021 (FR) 2105352

(51) Int. Cl. G06T 17/20; G06T 7/11; H04N 13/279

(52) U.S. Cl. CPC G06T 17/205; G06T 7/11; H04N 13/279

(57) ABSTRACT

Method for generating a view of a three-dimensional environment on a set of communication terminals based on a model of the environment that is stored on a server in the form of a grid of voxels, this server implementing steps of
partitioning (S1) the grid into a set of sub-grids;
generating (S2) a surface mesh for each sub-grid;
for each sub-grid, simplifying (S3) a sub-part of the mesh excluding an edge area of the mesh; and creating a table associating each vertex of the edge with a voxel;
assembling (S4) the meshes of the sub-grids, using this table, in order to form a global surface mesh;
transmitting (S5) the global surface mesh to the communication terminals, and generating (S6) a view of the three-dimensional environment based on the global surface mesh and on a point of view associated with each of the communication terminals.

### FIELD OF THE INVENTION

The present invention relates to the generation, by a set of terminals, of a view of a three-dimensional environment managed by the same computer server. It applies in particular to the field of multi-user virtual universes, in particular of the “video games” type.

### BACKGROUND OF THE INVENTION

The field of virtual three-dimensional environments is growing rapidly. This type of environment allows a large number of users to interact in an environment by modifying certain characteristics and navigating in the most realistic manner possible.

The movements of a user impact their point and their field of view, so that the display of the three-dimensional environment must be changed constantly. Additionally, the movement of a user can be visible to other users, which also has an impact on the personal view that they must have of the world.

In addition, some three-dimensional environments allow users to make changes, which may impact the environment by hollowing out existing objects, for example, or creating new objects. These modifications must also be reflected in the view that the other users have of the three-dimensional environment.

Among the various existing three-dimensional environments, it is possible in particular to cite the one implemented by the Applicants and called “Dual Universe.” Dual Universe is a massively multi-player spatial simulation video game. The game takes place in a “single, continuous, and undivided” universe and is a first person game.

Explanations on the environment implemented by the game can be found on the web site: https://www.dualuniverse.game, or on the Wikipedia page, which itself provides numerous documentary references: https://en.wikipedia.org/wiki/Dual_Universe

Of course, other three-dimensional environments are available, such as those implemented in the “Mniecraft” game.

There are various ways to model a three-dimensional environment. One possibility is to discretize the environment into a matrix, or “grid,” of voxels, in the same way as a two-dimensional digital image can be discretized from an array of pixels. The “Dual Universe” environment, in particular, operates on the basis of such modeling.

In order to be able to view the three-dimensional environment, data on this environment must be transmitted to the communication terminals associated with the users. Because of the recurrent interactions of the users, these data must be transmitted, at least in part, in a very regular manner so as to “refresh” the view that the users have of the three-dimensional environment.

Yet, a voxel model of a large environment such as a universe used in an immersive game like Dual Universe, Minecraft, etc. implies an extremely large amount of data. The volume of data depends directly on the size of the environment and the discretization used.

Therefore, the volume to be transferred from the server that manages the three-dimensional environment and the various communication terminals is also very substantial and may involve very high constraints on both the communication network and the computing resources implementing the server and/or the communication terminals.

However, as soon as the choice is made not to (drastically) limit the size of the environment managed by a single server, two avenues seem possible.

It is first possible to transmit the voxel model to the users. However, such an approach may cause congestion of the communication network, harming the quality of service perceived by users, in particular those who do not have a very high transfer rate. Additionally, it requires users' communication terminals to be powerful enough to perform the conversions of the voxel model into a data structure enabling it to be rendered on a screen or any other human-machine interface (virtual reality mask, etc.). Also, a host typically requires payment for the use of outgoing bandwidth, and this approach may therefore have a significant economic impact.

Another avenue consists in performing this conversion on the server and transmitting the data to be viewed to each user. However, this mechanism comes up against the fact that the cost of the calculations on the server side is proportional to the number of users and that the data to be calculated depend on the point of view of the users in the environment and are therefore different for each user. The server then requires substantial computing resources, which increases its cost, which may become prohibitive for the operator of such a three-dimensional environment.

A proposal adopted by some systems then consists in limiting the size of the universes and associating a distinct server with each universe, whereupon only a limited number of users can interact. However, this proposal forms a limitation which is detrimental to the recreational and immersive possibilities that these three-dimensional environments can offer.

### SUMMARY OF THE INVENTION

The present invention aims to provide a solution that at least partially overcome the aforementioned drawbacks. It is in particular to allow the viewing of a single three-dimensional environment by a multitude of mobile terminals, by minimizing the necessary resources (transmission and calculation), without impacting the quality both of the viewing itself and of the user experience (in terms in particular of jitter, reaction time, etc.).

To this end, according to a first aspect, the present invention can be implemented by a method for generating a view of a three-dimensional environment over a set of communication terminals from a model of said environment stored on a server in the form of a grid of voxels, said server implementing steps of
partitioning of at least a portion of said grid into a set of sub-grids;
generating an surface mesh for each sub-grid of said set,
for each of said sub-grids, simplification of a sub-part of said surface mesh excluding an edge area of said surface mesh; and creating a table associating each vertex of said edge with a voxel;
assembly of the surface meshes of said sub-grids of said set, using said table, in order to form a global surface mesh;
transmitting said global surface mesh to said communication terminals, and generating a view of said three-dimensional environment based on said global surface mesh and on a point of view associated with each of said communication terminals.

According to preferred embodiments, the invention comprises one or several of the following features which may be used separately or in partial combination with each other or in total combination with each other:
a transition surface is associated with said voxels and in that said surface meshes are generated based on said transition surfaces;
when said server detects a modification of said model, it inserts a request in a queue for recalculation of the surface mesh corresponding to said modification, and in that the recalculation requests present in said queue and relating to one and the same sub-grid are processed so as to perform that a single generation of a surface mesh for said sub-grid;
the assembly step comprises a sub-step of additional simplification of the global surface mesh.

According to another aspect, the invention may also be implemented by a computer program comprising instructions for implementing the method as previously described when executed on one or more information processing platforms.

Other embodiments of the invention relate to a server for generating a view of a three-dimensional environment from a model of said environment, comprising a memory for storing said model in the form of a grid of voxels, and processing means for implementing:
partitioning of at least a portion of said grid into a set of sub-grids;
generating a surface mesh for each sub-grid of said set,
for each of said sub-grids, simplification of a sub-part of said surface mesh excluding an edge area of said surface mesh; and creating a table associating each vertex of said edge with a voxel;
assembly of the surface meshes of said sub-grids of said set, using said table, in order to form a global surface mesh;
transmission of said global surface mesh to a set of communication terminals, each one being provided for generating a view of said three-dimensional environment based on said global surface mesh and on a point of view associated with each of said communication terminals.

According to preferred embodiments, the invention comprises one or several of the following features which may be used separately or in partial combination with each other or in total combination with each other:
a transition surface is associated with said voxels and in that said surface meshes are generated based on said transition surfaces;
The server is further configured to, when said server detects a modification of said model, it inserts a request in a queue for recalculation of the surface mesh corresponding to said modification, and that the recalculation requests present in said queue and relating to one and the same sub-grid are processed so as to perform a single generation of a surface mesh for said sub-grid;
the assembly comprises an additional simplification of the global a surface real mesh.

Other embodiments of the invention relate to a system comprising a server as defined above and at least one communication terminal

Further features and advantages of the invention will become apparent from the following description of a preferred embodiment of the invention, given by way of example and with reference to the attached drawings

### BRIEF DESCRIPTION OF THE FIGURES

The attached drawings show the invention:

FIG. 1 schematically shows a general context wherein the invention may fit.

FIG. 2 schematically shows the principle of the voxels and vertices, according to one embodiment of the invention

FIG. 3 schematically shows a flowchart of a method according to an embodiment of the invention:

FIG. 4 shows a voxel and the associated vertices;

FIG. 5 schematically shows an example grid representing a three-dimensional environment and a division into sub-grids;

### DETAILED DESCRIPTION OF EMBODIMENTS OF THE INVENTION

The invention applies in particular to massively multi-player video games wherein the various players can interact in a virtual and three-dimensional environment, or universe. However, the invention can also find applications in other business fields which require sharing the same three-dimensional environment among several users simultaneously connected to a server managing this environment.

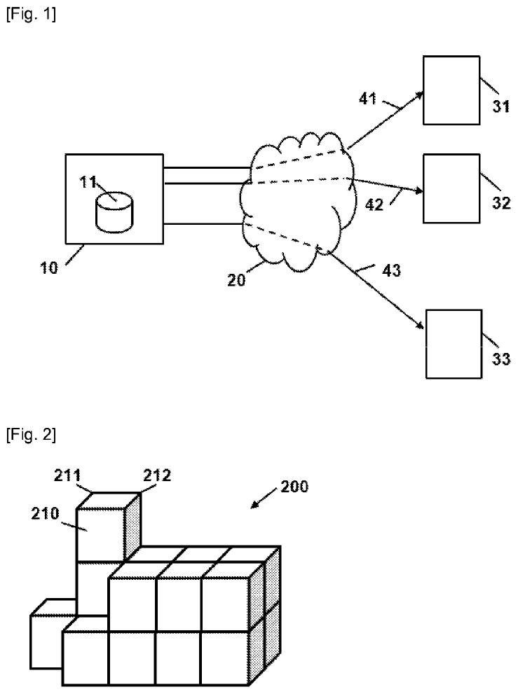

FIG. 1 shows a context wherein the invention may fit according to one embodiment.

At least one communication terminal 31, 32, 33 is connected to a server 10 via a communication network 20.

These communication terminals can be any information processing platforms allowing the communication of information through telecommunication networks. It may in particular be computers, consoles connected to a computer, smart phones, etc.

These communication terminals also have at least one processor and a memory for storing computer instructions. The communication means can allow the connection to different types of access networks: cellular networks, especially 4th or 5th generation, local networks such as WLAN or WIFI, or proximity networks such as Bluetooth or NFD (Near Field Communication), etc.

The communication network 20 can be seen as an interconnection of sub-networks which may comprise a global network, such as the Internet, in order to allow remote users to connect to the same server. The communication network may also comprise access networks enabling the connection of the communication terminals 31, 32, 33 to the global “Internet” network.

The server 10 can be seen as a device for processing unique information, or as a functional server which can be deployed on a plurality of devices arranged in the form of a server farm or a cloud computing infrastructure.

The server has a memory (or a set of memories) allowing storage of a model 11 of the three-dimensional environment in the form of a grid of voxels.

The server also has software means for generating a global surface mesh from this model. This global surface mesh can be transmitted to communication terminals by messages 41, 42, 43, respectively.

In the context of the invention, a plurality of users (or players) of communication terminals can share a same three-dimensional environment 11 managed by a single (functional) server 10. As will be seen later, the generation of a global surface mesh by the server reduces the amount of information to be transmitted to the terminals (compared to the transmission of the voxel model, for example).

The terminals can then generate a (subjective) view of this three-dimensional environment based on this global surface mesh. This mesh is the same for all terminals, but the view is subjective and depends on the position and parameters of view (direction, angle, etc.) of each user.

Hereinafter, a “voxel” (for “Volume Element”) refers to the 3-dimensional equivalent of a pixel in 2D digital imaging. If an isotropic 3D universe is considered, a voxel has the appearance of an elementary cube.

In the same way as a “pixel,” it is possible to associate data with a voxel. These data can in particular guide the appearance of the voxel during a display. They can in particular determine a color, a degree of transparency, a light intensity, etc.

The concept of a voxel is conventional in 3D imaging and is explained in detail in particular on the Wikipedia page: https://fr.wikipedia.org/wiki/Voxel

FIG. 2 shows an object 200 discretized into voxels, some being visible, others being masked.

Each voxel 210 may have 8 corresponding vertices, 211, 212, etc. A vertex is a top of the voxel which can be characterized by three coordinates x, y, z, in a reference frame.

A three-dimensional environment 11 may be considered as a three-dimensional grid of voxels. An object of this environment is thus represented by the assignment of a particular value to the voxels corresponding to its location. The value of these voxels may in particular correspond to the appearance of this object: color, material, etc.

An object may be of very large size (for example a planet), or of a smaller size (spacecraft, characters or even tools).

The grid representing the three-dimensional environment may be of considerable size and depends both on the size of this environment and on the resolution of the discretization (that is, the size of the voxels relative to the size of the universe).

One of the benefits of such a model of an environment in the form of a grid of voxels is the relative simplicity of its modification by users: it may in fact suffice to modify one value of a voxel. For example, constructing an object amounts to modifying the value of voxels corresponding to the location and the geometry of this object. Creating an object (for example the ground of a planet) amounts to assigning a “transparent” value (corresponding to the air) to the voxels of the extruded region, which automatically leaves the masked voxels visible.

According to various resolution modes, it is possible to associate, with each voxel directly, its color or rendering information, or else information of a higher semantic level, such as for example a material (dirt, rock, metal, plastic, air, etc.). In the latter case, the rendering (in particular the color, the intensity, etc.) will be determined from this semantic information in a subsequent step, for example by the rendering engine deployed on each communication terminal.

Additionally, other types of information may be associated with the voxels of the grid. For example, geometric information may be associated therein, in particular information defining a transition surface.

This transition surface makes it possible to influence the appearance of the voxel at a smaller scale level than that of the voxel. In particular, it makes it possible to model smooth surfaces (that is, without discontinuities) over several voxels.

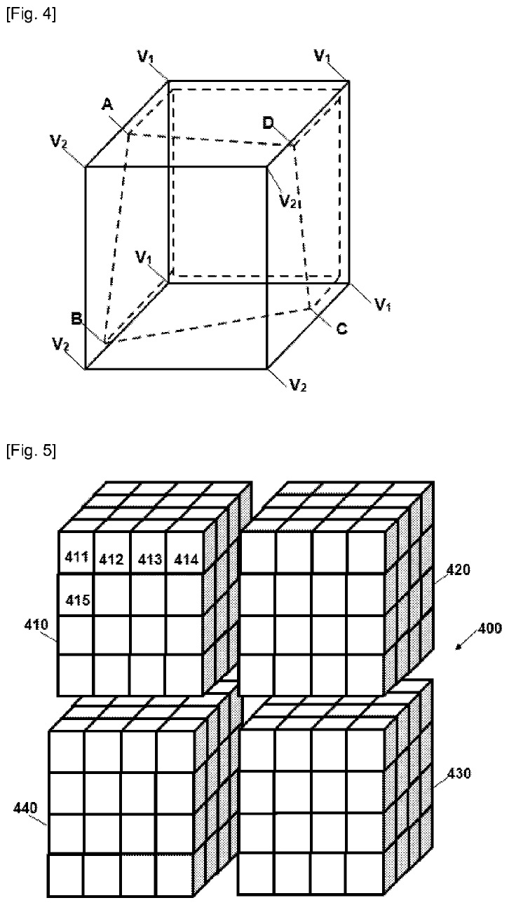

FIG. 4 shows a voxel for which 8 vertices are represented V₁₁, V₁₂, V₁₃, V₁₄, V₂₁, V₂₂, V₂₃, V₂₄, and a transition surface A, B, C, D.

By indicating, for example, the position of the 4 vertices A, B, C, D, it is possible to define a quadrilateral that partitions the voxel into two parts:
a first part, V₁₁, V₁₂, V₁₃, V₁₄, V₂₁, V₂₂, V₂₃, V₂₄, represented by dotted lines in FIG. 4, may correspond to the rendering value (color, material, etc.) of the voxel, and
a second part V₂₁, V₂₂, V₂₃, V₂₄, A, B, C, D may correspond to the rendering value of the neighboring voxel by the face V₂₁, V₂₂, V₂₃, V₂₄.

This transition surface is essentially operative when the neighboring voxel is transparent. In which case, the voxel V₁₁, V₁₂, V₁₃, V₁₄, V₂₁, V₂₂, V₂₃, V₂₄ can be represented as a shape V₁₁, V₁₂, V₁₃, V₁₄, V₂₁, V₂₂, V₂₃, V₂₄, and not as a cube.

If the transition surfaces are correctly defined for the neighboring voxels, by the other faces (V₁₂, V₁₃, V₂₂, V₂₃), (V₁₁, V₁₄, V₂₁, V₂₄), (V₁₄, V₁₃, V₂₄, V₂₃), (V₁₁, V₁₂, V₂₁, V₂₂), it is thus possible to obtain, by the concatenation of the respective interface surfaces, a continuous surface over several voxels. This result allows a more natural aesthetic rendering, and makes it possible to avoid a discretization of the objects and the landscape, such as, for example, with the “Minecraft” environment.

From such a model of the environment, it is possible to generate a global surface mesh of the environment. This mesh is a data structure representing only the surface of the three-dimensional environment, that is, which may be visible to the different users based on their point of view. This mesh, which does not depend on users, is generated whenever necessary and transmitted to the various communication terminals connected to the server. As mentioned above, each terminal can then generate a view, or a “rendering,” of the universe based on both this global surface mesh and its subjective data (position in the environment, direction/angle of view, etc.).

According to the invention, the generation of the global surface mesh is carried out by the server in several steps.

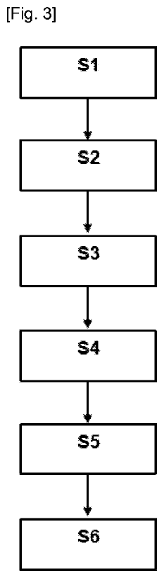

A first initial step, S1 in FIG. 3, consists in partitioning at least a part of the grid of the three-dimensional environment into a set of sub-grids.

It appears that considering the entire grid of voxels in each step is doubly ineffective:
the memory consumption is of the order of several gigabytes, just for the input voxel datum of the algorithm,
Additionally, the slightest modification of the grid of voxels would require a complete recalculation of the mesh and application of the simplification algorithm (steps S2-S6 in FIG. 3)

To remedy these problems, the main grid is divided into sub-grids. These sub-grids may be cubic and of fixed size.

FIG. 5 schematically shows an example of a grid 400 representing a three-dimensional environment. In this example, this grid was partitioned into 4 sub-grids, 410, 420, 430, 440. Each of these sub-grids 410 comprises a plurality of voxels 411, 412, 413, 414, 415, etc. Of course, in reality, the sub-grids comprise a substantially larger number of voxels, and the grid comprises a much higher number of sub-grids. Also, the gap between the sub-grids in FIG. 5 is intended solely for the clarity of the figure and does not represent any concrete reality: thus, the vertex A is on the edge V₁₁-V₂₁, the vertex B is on the edge V₁₄-V₂₄, etc.

Each sub-grid therefore forms a data structure of size substantially smaller than that of the global grid. In addition, it is possible to determine the size of the sub-grids optimally based on the computational resources available to the server 10.

The subsequent steps of the generation of the global surface mesh can be carried out initially, and again when the model 11 is modified.

These modifications may have, as mentioned above, other causes: the creation of a new object, the destruction of an object, the modification of an object, etc. Generally, these various causes result in the modification of a value associated with a voxel (color, material, transition surface, etc.).

According to one embodiment, the detection of a modification in the model generates a recalculation request, which is placed in a queue. This queue is consumed by a mesh generation module. A mechanism makes it possible to aggregate several recalculation requests: thus, it would be counterproductive to calculate a surface mesh several times for several successive modifications of a single sub-grid, for example.

Thus, according to one embodiment of the invention, when the mesh generation module is available, it consumes the first request in the queue and searches for other requests relating to the same sub-grid as this first request (in the entire queue or according to a time window, etc.), and generates a surface mesh for this sub-grid only once, taking into account the various modifications (corresponding to the respective requests).

Thus, according to this embodiment, a queue of the FIFO type (“First In, First Out”) is set up. This embodiment is interesting insofar as there is a fixed and finite computing capacity on the server, and it makes it possible to reduce the mesh update frequency if the server is saturated and to have faster updates in the case where there is available computing capacity. This approach is also beneficial in our context because it allows a reduced number of transmissions of the mesh and thus a reduced bandwidth cost.

In a case where the mesh update request would be highly variable, it could be beneficial to opt for another embodiment based on a computing infrastructure of dynamic size. A dynamic size infrastructure would also be relevant if the update frequency of the meshes was a metric to be strongly guaranteed.

In a step S2, the server can generate a surface mesh for one or more sub-grids. Typically, only the sub-grids impacted by a modification of the model can be generated again.

The voxel data typically cannot be viewed directly. Therefore, a mesh representing the interface between the opaque voxels and the transparent voxels is generated to allow a user to view this data. If only the appearance is necessary, all the information that is not at this interface is therefore completely superfluous.

To generate a mesh representing the voxel data, pairs of adjacent voxels can be considered. If one of the two voxels has an opaque material and the other transparent, then a quadrilateral is generated between the two voxels to which the opaque material is assigned.

According to one embodiment, the position of the vertices of the quadrilateral is adjusted using the information on the transition surface associated with the voxel, as explained above.

In this way, considering the set of pairs of adjacent voxels of a sub-grid, a surface mesh is effectively obtained, that is, a data structure describing only the interface surface between the opaque voxels (or voxel parts) (corresponding to a material different from the air) and the transparent voxels (or voxels) (corresponding to the air). This surface mesh corresponds to the visible part of the three-dimensional environment.

According to one embodiment, the generation of a surface mesh for a sub-grid comprises a triangulation sub-step, consisting in transforming the quadrilaterals corresponding to each voxel into triangles.

This triangulation generates a tessellation, or tiling, of the sub-grid. The number of triangles can nevertheless be very high, which is sub-optimal for efficient processing by the server.

The literature proposes numerous solutions to simplify such triangulation. In particular, it is possible to aggregate the coplanar triangles to constitute polygons of larger size.

A simple simplification can be based on the analysis of each point (vertex) of the surface mesh to verify whether the adjacent triangles are coplanar or not, and if so, this point is deleted and the triangles in question are merged into a single polygon.

Other algorithms exist and make it possible to optimize the simplification of the mesh.

It should be noted that in our case, the starting meshes are not of “good quality.” In particular, the mesh available at this stage is not manifold. A mesh is said to be n-manifold when, at a ridge, a maximum of n planar surfaces are connected. A 2-manifold mesh is therefore an array of surfaces for which the ridges are the border of at most 2 planar surfaces.

Non-manifold meshes are generally difficult to handle and pose problems to numerous simplification algorithms. A selection must therefore be made to choose suitable algorithms within the scope of the specific constraints of the invention.

Thus, we can cite the QSlim algorithm, available as a free software tool, and described in the thesis of the author M. Garland, “Quadric-based Polygonal Surface Simplification,” School of Computer Science of Pittsburgh, May 1999.

It is also possible to cite the algorithm described in “Fast and Robust QEF Minimization using Probabilistic Quadrics” by Philip Trettner, Leif Kobbelt, available at http://www.graphics.rwth-aachen.from/public/03308/

According to the invention, the simplification algorithm is implemented on only a sub-part of the surface mesh of the sub-grid. This sub-part corresponds to the sub-grid which has been excluded from an edge area.

Indeed, the mesh is excluded from an edge area. This edge area may be defined by a margin on the boundaries of the sub-grid.

In particular, it is possible to define the edge area by the set of triangles of the mesh whereof at least one of the vertices belongs to the edge of the mesh of the sub-grid (that is, to a voxel having an immediate neighbor in the mesh of another sub-grid).

The purpose is to avoid any loss of information, which will be necessary to determine the junction between the two sub-grids and to evaluate the simplification error of the geometry.

This table indicates which voxels come from the different vertices of the triangles at the edge of the area.

According to one embodiment of the invention, a vertex is associated with a single voxel according to a predefined rule. For example, based on a given reference frame, each vertex is arbitrarily associated with the voxel at the bottom left.

The table thus allows a single match between the grid of voxels and the grid of vertices: [(vertex 1, voxel 1), (vertex 2, voxel 2), etc.]

Each mesh can be generated independently of the neighboring meshes and requires only the memory necessary for a sub-grid. Additionally, the fact that the sub-grids have a fixed and known size makes it possible to dimension the server optimally in line with the choice of the size of the sub-grids.

For example, it is possible to choose to work with sub-grids of 32³≅32000 voxels. The data structure of each voxel represents around thirty bytes of information. A sub-grid therefore represents about 1 megabyte.

In general, a major part of a sub-grid contains no geometry (because there is no transition between air and material). The corresponding mesh is therefore generally small faced with the size of the voxel data. For non-degenerated constructions, it is of the order of 10 kilo-bytes per sub-grid mesh after the step of partial simplification of the mesh of the cell.

An example of a mesh may be composed of 4000 sub-grids, which corresponds to a processing size of a few hundred megabytes for the manufacture and simplification of the complete mesh.

In a step S4, the server assembles the surface meshes of the sub-grids in order to form a global surface mesh.

As seen previously, the server can only generate the meshes of sub-grids impacted by a modification of the model of the environment. Therefore, the assembly can consist in assembling sub-grids of varying ages.

The intermediate meshes generated in the preceding step S3 are relatively small due to the simplification and the controlled size of the sub-grids. There is no particular problem for the server to have them in memory simultaneously.

This assembly consists in concatenating the meshes of each sub-grid and in using the tables associated with each sub-grid to form the junction area between two contiguous meshes.

According to one embodiment of the invention, all junction voxels in the tables are observed. If there is a transition from air to material in the junction (air in one sub-grid and material in the neighboring sub-grid), triangles are added by connecting the vertices associated with these voxels.

According to one embodiment of the invention, the assembly step further comprises a sub-step of simplifying the global surface mesh.

The algorithm of this simplification can be similar to the one deployed in step S3, but on the entire grid and without excluding an edge area.

This new simplification makes it possible on the one hand to simplify the edge areas (which could not be simplified during step S3), now joined in pairs, and also to detect areas that can be simplified on several sub-grids. For example, polygons can be coplanar on two (or more) sub-grids and, to which it is possible to simplify the overall mesh by merging these polygons.

This global surface mesh, after optional additional simplification, can then be transmitted by the server, during a step S5, to the communication terminals.

Each of them can then independently generate, in a step S6, a view of the three-dimensional environment based on said global surface mesh and on a point of view associated with the terminal. This step of constructing a view from an areal mesh is conventional per se and can be implemented by different 3D rendering techniques.

By way of example, mention may be made of the well-known method of the “Z buffer,” which makes it possible to manage the visibility problem by determining which elements of the scene must be rendered, which are hidden by others and wherein order the display of the objects should be done.

This step of generating a view may further comprise a projection of the surface mesh toward the two-dimensional surface representing the screen whereupon the user of the terminal can view the environment.

Thus, according to the invention, only data representing a simplified surface mesh are transmitted to the communication terminals. These data are slightly bulky compared to that of the voxel model. Additionally, this surface mesh is agnostic relative to users' points of view. Thus, a transmission of the “broadcasting” type can be implemented and part of the calculations offloaded to the user terminals.

The division of a grid into sub-grids moreover makes it possible to keep the load of the server under control by making it possible to manipulate data structures of reduced size and by minimizing the volume of data to be recalculated at each modification of the environment.

This mechanism is particularly appropriate in the case where the number of modifications of the environment is relatively small compared to the number of users navigating in the environment and must therefore receive environment updates. Indeed, a modification will impact only a sub-grid and require only a small marginal minimum: recalculation of the sub-grid, and recalculation of the global surface mesh by assembly.

Of course, the present invention is not limited to the examples and embodiment described and shown, but is defined by the claims. In particular, it is susceptible to numerous variants accessible to the skilled artisan.

1. A method for generating a view of a three-dimensional environment over a set of communication terminals from a model of said environment stored on a server in the form of a grid of voxels, said server implementing steps of
partitioning (S1) of at least a portion of said grid into a set of sub-grids;
generation (S2) of a surface mesh for each sub-grid of said set,
for each of said sub-grids, simplification (S3) of a sub-part of said surface mesh excluding an edge area of said surface mesh; and creating a table associating each vertex of said edge with a voxel;
assembly (S4) of the surface meshes of said sub-grids of said set, using said table, in order to form a global surface mesh;
transmitting (S5) said global surface mesh to said communication terminals, and generating (S6) a view of said three-dimensional environment based on said global surface mesh and on a point of view associated with each of said communication terminals.

2. The method according to claim 1, wherein a transition surface is associated with said voxels and in that said surface meshes are generated based on said transition surfaces.

3. The method according to claim 1, wherein when said server detects a modification of said model, it inserts a request in a queue for recalculation of the surface mesh corresponding to said modification, and in that the recalculation requests present in said queue and relating to one and the same sub-grid are processed so as to perform that a single generation of a surface mesh for said sub-grid.

4. The method according to claim 1, wherein the assembly step (S4) comprises a sub-step of additional simplification of the global surface mesh.

5. A computer program having instructions for implementing the method according to claim 1, when executed on one or more information processing platforms.

6. A server for generating a view of a three-dimensional environment from a model of said environment, comprising a memory for storing said model in the form of a grid of voxels, and processing means for implementing:
partitioning (S1) of at least a portion of said grid into a set of sub-grids;
generation (S2) of a surface mesh for each sub-grid of said set,
for each of said sub-grids, simplification (S3) of a sub-part of said surface mesh excluding an edge area of said surface mesh; and creating a table associating each vertex of said edge with a voxel;
assembly (S4) of the surface meshes of said sub-grids of said set, using said table, in order to form a global surface mesh;
transmission (S5) of said global surface mesh to a set of communication terminals, each one being provided for generating (S6) a view of said three-dimensional environment based on said global surface mesh and on a point of view associated with each of said communication terminals.

7. The server according to claim 6, wherein a transition surface is associated with said voxels and in that said surface meshes are generated based on said transition surfaces.

8. The server according to claim 6, further configured to, when said server detects a modification of said model, it inserts a request in a queue for recalculation of the surface mesh corresponding to said modification, and that the recalculation requests present in said queue and relating to one and the same sub-grid are processed so as to perform that a single generation of a surface mesh for said sub-grid.

9. The server according to claim 6, wherein the assembly step (S4) comprises an additional simplification of the global surface mesh.

10. A system comprising a server according to claim 6 and at least one communication terminal.
